(19) United States
(12) Patent Application Publication
(10) Pub. No.: US 2026/0163790 A1
(43) Pub. Date: Jun. 11, 2026

(54) PROVIDING EXCLUSIVE ACCESS TO MANAGEMENT PLANE SERVICES OF A NETWORK DEVICE

(71) Applicant: Juniper Networks, Inc., Sunnyvale, CA (US)

(72) Inventors: Vamsi Krishna PENDELA, Bangalore (IN); Polisetty Rama SUBBAIAH, Banaglore (IN)

(21) Appl. No.: 18/973,372

(22) Filed: Dec. 9, 2024

(51) Int. Cl. H04L 41/0681; H04L 41/0803

(52) U.S. Cl. CPC H04L 41/0681; H04L 41/0803

(57) ABSTRACT

A network device may receive, from a user, a command for exclusive access to management plane services, and may provide, to other users, a wall message indicating granting of the exclusive access to the management plane services. The network device may set a time limit for the exclusive access to the management plane services, and may receive a request for a check, a diagnostic, or a statistic from the user and within the time limit. The network device may implement the request to generate a check result, a diagnostic result, or the statistic, and may provide the check result, the diagnostic result, or the statistic to the user.

### BACKGROUND

Support engineers frequently request customers to place problematic network devices into a maintenance mode for isolated troubleshooting.

### SUMMARY

Some implementations described herein relate to a method. The method may include receiving, from a user, a command for exclusive access to management plane services, and providing, to other users, a wall message indicating granting of the exclusive access to the management plane services. The method may include setting a time limit for the exclusive access to the management plane services, and receiving a request for a check, a diagnostic, or a statistic from the user and within the time limit. The method may include implementing the request to generate a check result, a diagnostic result, or the statistic, and providing the check result, the diagnostic result, or the statistic to the user.

Some implementations described herein relate to a network device. The network device may include one or more processors. The one or more processors may be configured to receive, from a user, a command for exclusive access to management plane services, and provide, to the user, a response granting the user the exclusive access to the management plane services. The one or more processors may be configured to provide, to other users, a wall message indicating granting of the exclusive access to the management plane services, and set a time limit for the exclusive access to the management plane services. The one or more processors may be configured to receive a request for a check, a diagnostic, or a statistic from the user and within the time limit, and generate a check result, a diagnostic result, or the statistic. The one or more processors may be configured to provide the check result, the diagnostic result, or the statistic to the user.

Some implementations described herein relate to a non-transitory computer-readable medium that stores a set of instructions for a network device. The set of instructions, when executed by one or more processors of the network device, may cause the network device to receive, from a user, a command for exclusive access to management plane services, wherein the exclusive access to the management plane services enables the user to provide operational commands, remote procedure calls, and configuration updates to the network device. The set of instructions, when executed by one or more processors of the network device, may cause the network device to provide, to other users, a wall message indicating granting of the exclusive access to the management plane services, and set a time limit for the exclusive access to the management plane services. The set of instructions, when executed by one or more processors of the network device, may cause the network device to receive a request for a check, a diagnostic, or a statistic from the user and within the time limit, and implement the request to generate a check result, a diagnostic result, or the statistic. The set of instructions, when executed by one or more processors of the network device, may cause the network device to provide the check result, the diagnostic result, or the statistic to the user.

### BRIEF DESCRIPTION OF THE DRAWINGS

FIGS. 1A-1E are diagrams of an example associated with providing access to management plane services of a network device.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for providing access to management plane services of a network device.

### DETAILED DESCRIPTION

The following detailed description of example implementations refers to the accompanying drawings. The same reference numbers in different drawings may identify the same or similar elements.

Requesting customers to place problematic network devices into a maintenance mode is often necessary when a user (e.g., a support engineer) requires dedicated, exclusive access to the problematic network devices to evaluate performance, monitor processor usage, debug memory leaks, and/or the like. Once a network device is in the maintenance mode, the system engineer may perform initial checks (e.g., a system logs check, a configuration check, a connectivity check, and/or the like) on the network device, and may issue diagnostic commands (e.g., a ping command, a traceroute command, a show command, and/or the like) to the network device. The support engineer may also identify common issues, such as Internet protocol (IP) address conflicts, improperly configured subnet masks, out-of-date firmware or software, overheating hardware, and/or the like. The support engineer may correct any issues discovered during the initial checks, the diagnostic commands, or the review of common issues, and may test whether the corrections eliminated the issues. Such a process may be time consuming, and a customer may be unable to utilize the network device while the network device is placed in the maintenance mode. Thus, current techniques for troubleshooting network devices consume computing resources (e.g., processing resources, memory resources, communication resources, and/or the like), networking resources, and/or the like, associated with preventing customers from utilizing network devices placed in the maintenance mode, handling customer complaints associated with the customers being unable to utilize the network devices, handling lost traffic caused by placing network devices in the maintenance mode, and/or the like.

Some implementations described herein relate to a network device that provides access to management plane services of a network device. For example, the network device may receive, from a user, a command for exclusive access to management plane services, and may provide, to other users, a wall message indicating granting of the exclusive access to the management plane services. The network device may set a time limit for the exclusive access to the management plane services, and may receive a request for a check, a diagnostic, or a statistic from the user and within the time limit. The network device may implement the request in order to generate a check result, a diagnostic result, or the statistic, and may provide the check result, the diagnostic result, or the statistic to the user.

In this way, the network device provides access to management plane services of a network device. For example, the network device may provide a support engineer with exclusive access to management plane services for issue debugging or troubleshooting. The network device may enable the support engineer (e.g., via a command line interface (CLI) of the network device or via a remote procedure call (RPC) session) to temporarily assume exclusive access to the management plane services and without requiring the network device to enter maintenance mode or stop ongoing applications of customers. Thus, the network device conserves computing resources, networking resources, and/or the like that would otherwise have been consumed by preventing customers from utilizing network devices placed in the maintenance mode, handling customer complaints associated with the customers being unable to utilize the network devices, handling lost traffic caused by placing network devices in the maintenance mode, and/or the like.

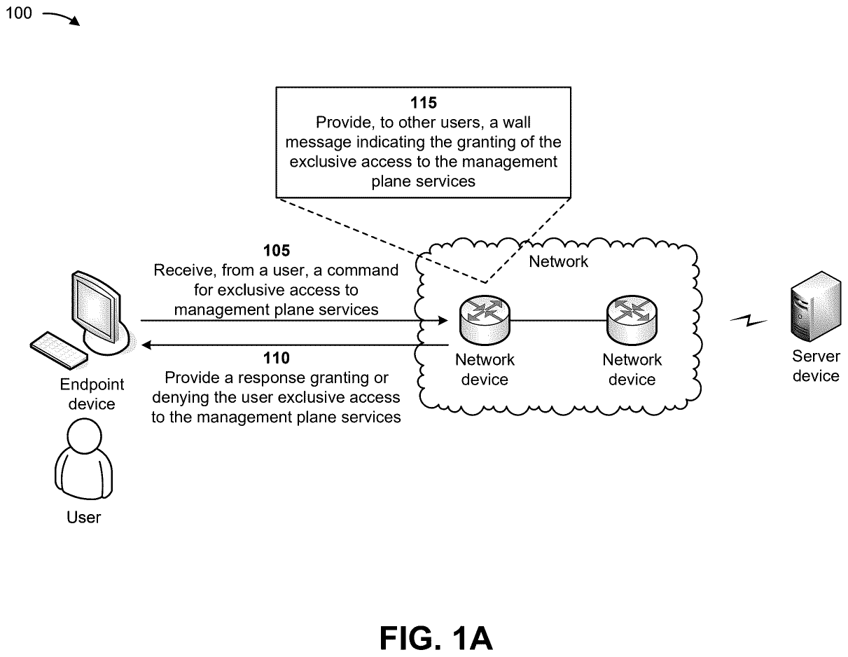

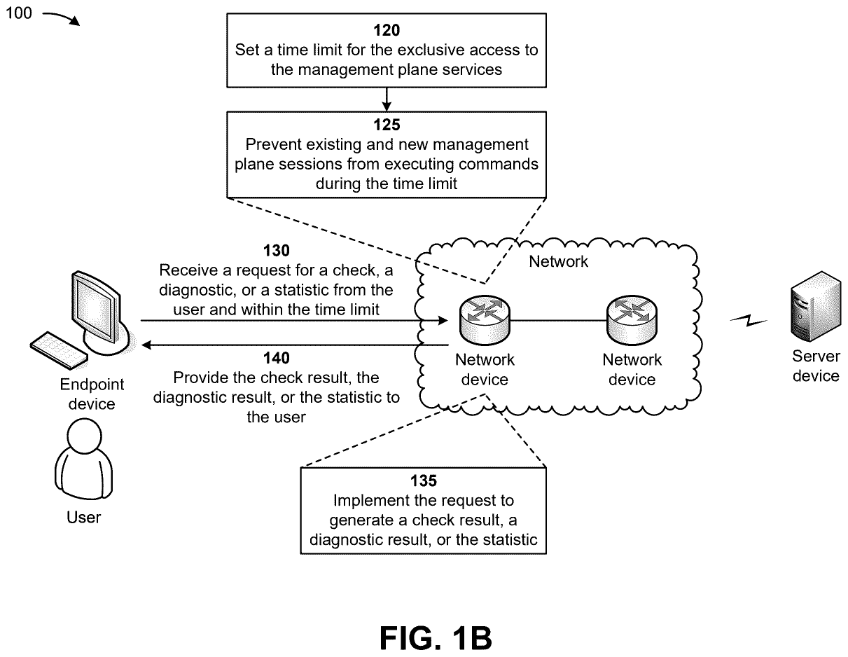

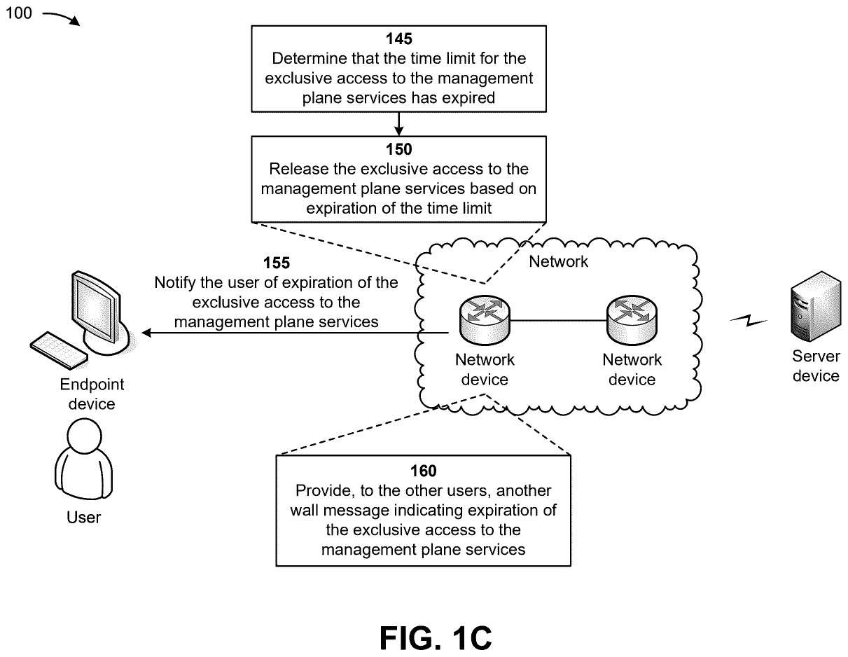

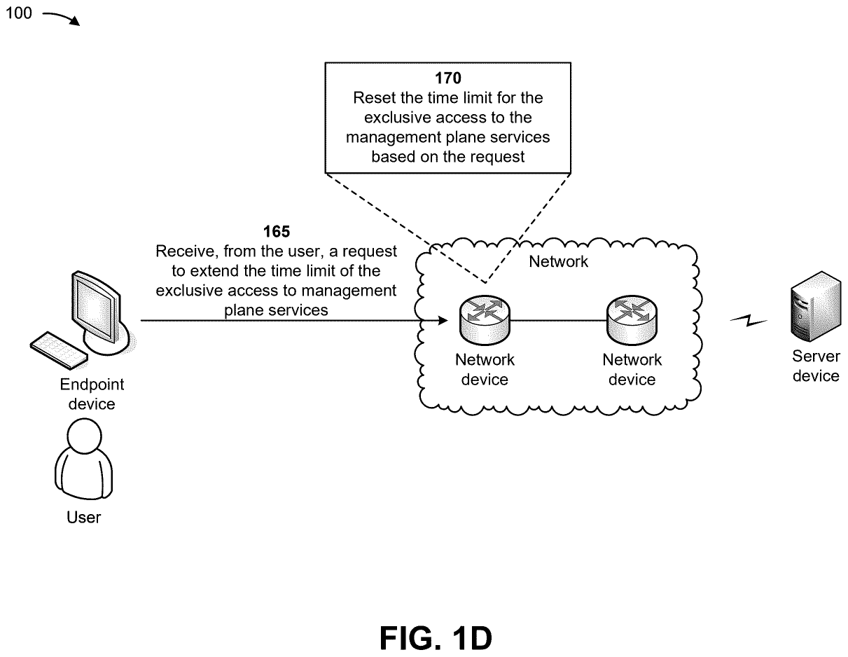

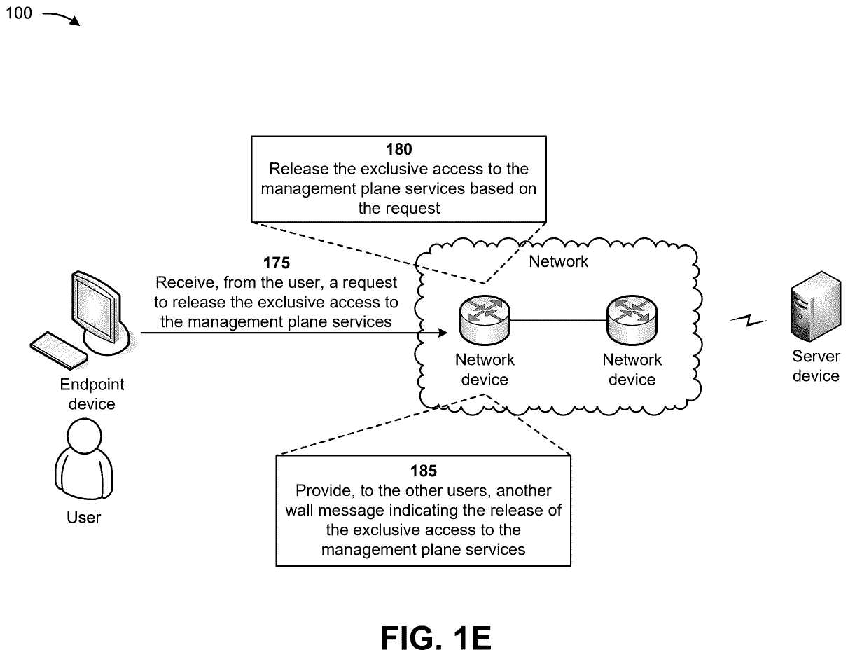

FIGS. 1A-1E are diagrams of an example 100 associated with providing access to management plane services of a network device. As shown in FIGS. 1A-1E, the example 100 includes an endpoint device associated with a network and a server device. The network may include multiple network devices. Further details of the endpoint device, the server device, the network, and the network devices are provided elsewhere herein.

As shown in FIG. 1A, and by reference number 105, the network device may receive, from a user, a command for exclusive access to management plane services. For example, the user (e.g., a system engineer) may utilize a CLI of the network device to input the command for the exclusive access to the management plane services of the network device, and the network device may receive the command via the CLI. Alternatively, the user may utilize the endpoint device to input the command for the exclusive access to the management plane services of the network device. The endpoint device may provide the command to the network device, and the network device may receive the command for exclusive access to the management plane services from the endpoint device. In some implementations, the command received from the endpoint device may be an RPC.

The exclusive access to the management plane services may enable the user (e.g., via the CLI or an RPC session) to temporarily assume an exclusive access without requiring the network device to enter maintenance mode or to stop ongoing applications. In some implementations, the exclusive access to the management plane services may be utilized when diagnosing issues related to high processor usage by the network device, memory leaks by the network device, or network bottlenecks. The exclusive access to the management plane services may enable the user to monitor network device performance without interference from other processes, which may ensure accurate diagnostics and timely resolutions. In some implementations, the exclusive access to the management plane services may be utilized during upgrades, downgrades, an in-service software upgrade (ISSU), or application of critical patches for the network device. The exclusive access to the management plane services may ensure that no other operations interfere with such processes, reducing a risk of failures or conflicts.

In some implementations, the exclusive access to the management plane services may be utilized in the event of a network device failure or critical incident. The exclusive access may enable the user to quickly isolate a problem and apply necessary fixes without waiting for the entire network device to enter a maintenance mode. This may reduce downtime and accelerate network device recovery. In some implementations, the exclusive access to the management plane services may be utilized when testing new features, debugging issues, or validating network device behavior in a controlled environment without the need to take the entire network device into a maintenance mode. The exclusive access to the management plane services may provide exclusivity to complete management plane services for both operational commands (e.g., RPCs) and configuration updates. In some implementations, the user may utilize the exclusive access to perform checks of the network device, run diagnostics for the network device, or collect statistics from the network device.

As further shown in FIG. 1A, and by reference number 110, the network device may provide, to other users, a wall message indicating granting of the exclusive access to the management plane services. For example, “wall message” refers to a message sent to all currently logged-in users on the network device, typically using a “wall” command (e.g., which stands for “write to all”) that allows the network device to broadcast important information to everyone simultaneously. If the network device grants the user the exclusive access to the management plane services based on the command for the exclusive access to management plane services, the network device may generate the wall message indicating the granting to the user of the exclusive access to the management plane services. The network device may provide the wall message to other users of the network device (e.g., to other endpoint devices, the server device, and/or the like) so that the other users are aware of the granting of the exclusive access to the management plane services to the user.

As further shown in FIG. 1A, and by reference number 115, the network device may provide a response granting or denying the user exclusive access to the management plane services. For example, the network device may determine whether to grant or deny the user the exclusive access to the management plane services. In some implementations, only a root user, a super user, or a maintenance user may be granted the exclusive access to the management plane services. The network device may implement one or more authorization or validation checks of the user wherever applicable and when determining whether to grant or deny the user the exclusive access to the management plane services. In some implementations, the network device may control the user or users who may be granted the exclusive access to the management plane services. For example, a user who is granted exclusive access may be part of a particular group or may be a super-user class user.

In some implementations, the network device may grant the user the exclusive access to the management plane services, and may generate a response (e.g., “granted exclusive access”) granting the user the exclusive access to the management plane services. In such implementations, the network device may provide the response (e.g., indicating the granting of the exclusive access) for display to the user via the CLI or may provide the response to the endpoint device. The endpoint device may provide the response (e.g., indicating the granting of the exclusive access) for display to the user. Alternatively, the network device may deny the user the exclusive access to the management plane services, and may generate a response (e.g., “permission denied”) denying the user the exclusive access to the management plane services. In such implementations, the network device may provide the response (e.g., indicating the denying of the exclusive access) for display to the user via the CLI or may provide the response to the endpoint device. The endpoint device may provide the response (e.g., indicating the denying of the exclusive access) for display to the user.

As shown in FIG. 1B, and by reference number 120, the network device may set a time limit for the exclusive access to the management plane services. For example, the time limit for the exclusive access to the management plane services may be configurable and may be designated in minutes (e.g., ten minutes), hours, and/or the like. If the network device grants the user the exclusive access to the management plane services, the network device may set the time limit for the exclusive access of the user to the management plane services. Upon expiration of the time limit, the network device may remove the user's exclusive access to the management plane services unless the user opts to extend the time limit.

As further shown in FIG. 1B, and by reference number 125, the network device may prevent existing and new management plane sessions from executing commands during the time limit. For example, during the exclusive access to the management plane services, the network device may prevent existing management plane sessions (e.g., CLI or RPC sessions) from executing commands (e.g., configuration updates, operational commands, and/or the like) during the time limit set for the exclusive access to the management plane services. Attempts to execute commands during the time limit by the existing management plane sessions may cause the network device to generate an error message (e.g., “Session holds exclusive lock. Please retry the command after some time”). At any point of time, the users of the existing management plane sessions may determine a status of the exclusive access by providing a command or an RPC to the network device requesting the status (e.g., “request system management plane exclusive access status”). The network device may respond to the status request with a response indicating the status of the exclusive access (e.g., “session holds exclusive lock” or “no exclusive lock found”).

In some implementations, during the exclusive access to the management plane services, the network device may prevent new management plane sessions (e.g., CLI or RPC sessions) from executing commands (e.g., configuration updates, operational commands, and/or the like) during the time limit set for the exclusive access to the management plane services. The users of the new management plane sessions may be permitted to login to the network device, but may be prevented from executing commands. In some implementations, the network device may deny the users of the new management plane sessions from login to the network device during the time limit set for the exclusive access.

As further shown in FIG. 1B, and by reference number 130, the network device may receive a request for a check, a diagnostic, or a statistic from the user and within the time limit. For example, the user may wish to utilize the exclusive access to the management plane services to perform a check of the network device, to determine a diagnostic of the network device, to calculate a statistic for the network device, and/or the like. The user may provide the request for the check, the diagnostic, or the statistic (e.g., within the time limit) via the CLI of the network device or via the endpoint device. The network device may receive the request for the check, the diagnostic, or the statistic from the CLI or the endpoint device.

As further shown in FIG. 1B, and by reference number 135, the network device may implement the request in order to generate a check result, a diagnostic result, or the statistic. For example, based on receiving the request for the check, the diagnostic, or the statistic, the network device may implement request for the check, the diagnostic, or the statistic. The network device may perform a check of the network device based on the request for the check, and may generate a check result based on performing the check. The network device may perform a diagnostic of the network device based on the request for the diagnostic, and may generate a diagnostic result based on performing the diagnostic. The network device may calculate the statistic for the network device based on the request for the statistic.

As further shown in FIG. 1B, and by reference number 140, the network device may provide the check result, the diagnostic result, or the statistic to the user. For example, the network device may display the check result, the diagnostic result, or the statistic to the user via the CLI of the network device. Alternatively, the network device may provide the check result, the diagnostic result, or the statistic to the endpoint device, and the endpoint device may display the check result, the diagnostic result, or the statistic to the user.

As shown in FIG. 1C, and by reference number 145, the network device may determine that the time limit for the exclusive access to the management plane services has expired. For example, unless the user releases the exclusive access to the management plane services or requests that the time limit be reset, the network device may utilize a timer to determine when the time limit for the exclusive access to the management plane services has expired (e.g., after ten minutes, twenty minutes, and/or the like). In some implementations, before the time limit expires, the network device may provide an indication of how much time remains until the time limit expires. The indication may be displayed to the user via the CLI of the network device or via the endpoint device.

As further shown in FIG. 1C, and by reference number 150, the network device may release the exclusive access to the management plane services based on expiration of the time limit. For example, based on determining that the time limit for the exclusive access to the management plane services has expired, the network device may release the exclusive access to the management plane services for the user. In some implementations, the network device may provide an indication of the release of the exclusive access to the management plane services. The indication may be displayed to the user via the CLI of the network device or via the endpoint device.

As further shown in FIG. 1C, and by reference number 155, the network device may notify the user of expiration of the exclusive access to the management plane services. For example, based on determining that the time limit for the exclusive access to the management plane services has expired, the network device may provide, to the user, a notification of the expiration of the exclusive access to the management plane services. The notification may be displayed to the user via the CLI of the network device or via the endpoint device. In some implementations, the network device may provide the notification to the user prior to releasing the exclusive access to the management plane services. This may enable the user to reset the time limit and extend the exclusive access to the management plane services prior to the network device releasing the exclusive access.

As further shown in FIG. 1C, and by reference number 160, the network device may provide, to the other users, another wall message indicating expiration of the exclusive access to the management plane services. For example, based on determining that the time limit for the exclusive access to the management plane services has expired, the network device may generate the other wall message indicating the expiration of the exclusive access to the management plane services. The network device may provide the other wall message to the other users of the network device (e.g., to other endpoint devices, the server device, and/or the like) so that the other users are aware of the expiration of the exclusive access to the management plane services.

As shown in FIG. 1D, and by reference number 165, the network device may receive, from the user, a request to extend the time limit of the exclusive access to the management plane services. For example, when the user receives the notification of the expiration of the exclusive access to the management plane services, the user may provide, to the network device, the request to extend the time limit of the exclusive access to the management plane services. The user may provide the request to extend the time limit to the network device via the CLI or via the endpoint device. The network device may receive the request to extend the time limit after releasing the exclusive access to the management plane services or prior to releasing the exclusive access to the management plane services.

As further shown in FIG. 1D, and by reference number 170, the network device may reset the time limit for the exclusive access to the management plane services based on the request. For example, based on receiving the request to extend the time limit, the network device may reset the time limit for the exclusive access to the management plane services for the user. In some implementations, the network device may regrant the exclusive access to the management plane services if the exclusive access to the management plane services has been released. Alternatively, the network device may continue to provide the exclusive access to the management plane services for the reset time if the exclusive access to the management plane services has not been released.

As shown in FIG. 1E, and by reference number 175, the network device may receive, from the user, a request to release the exclusive access to the management plane services. For example, at any point in time prior to the expiration of the time limit, the user may request the release of the exclusive access to the management plane services. In some implementations, the user may complete a check or a diagnostic prior to expiration of the time limit, and may no longer require the exclusive access to the management plane services. The user may provide the request to release the exclusive access to the management plane services to the network device via the CLI or via the endpoint device.

As further shown in FIG. 1E, and by reference number 180, the network device may release the exclusive access to the management plane services based on the request. For example, based on receiving the request to release the exclusive access to the management plane services, the network device may release the exclusive access to the management plane services for the user. In some implementations, the network device may provide an indication of the release of the exclusive access to the management plane services. The indication may be displayed to the user via the CLI of the network device or via the endpoint device.

As further shown in FIG. 1E, and by reference number 185, the network device may provide, to the other users, another wall message indicating the release of the exclusive access to the management plane services. For example, based on receiving the request to release the exclusive access to the management plane services, the network device may generate the other wall message indicating the release of the exclusive access to the management plane services. The network device may provide the other wall message to the other users of the network device (e.g., to other endpoint devices, the server device, and/or the like) so that the other users are aware of the release of the exclusive access to the management plane services.

In this way, the network device provides access to management plane services of a network device. For example, the network device may provide a support engineer with exclusive access to management plane services for issue debugging or troubleshooting. The network device may enable the support engineer (e.g., via a command line interface (CLI) of the network device or via a remote procedure call (RPC) session) to temporarily assume exclusive access to the management plane services and without requiring the network device to enter maintenance mode or stop ongoing applications of customers. Thus, the network device conserves computing resources, networking resources, and/or the like that would otherwise have been consumed by preventing customers from utilizing network devices placed in the maintenance mode, handling customer complaints associated with the customers being unable to utilize the network devices, handling lost traffic caused by placing network devices in the maintenance mode, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

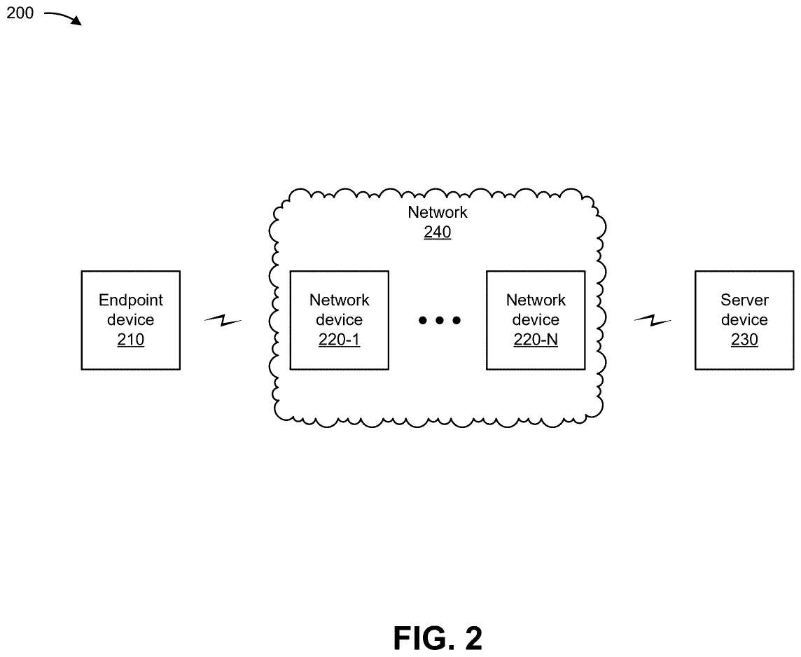

FIG. 2 is a diagram of an example environment 200 in which systems and/or methods described herein may be implemented. As shown in FIG. 2, environment 200 may include an endpoint device 210, a group of network devices 220 (shown as network device 220-1 through network device 220-N), a server device 230, and a network 240. Devices of the environment 200 may interconnect via wired connections, wireless connections, or a combination of wired and wireless connections.

The endpoint device 210 includes one or more devices capable of receiving, generating, storing, processing, and/or providing information, such as information described herein. For example, the endpoint device 210 may include a mobile phone (e.g., a smart phone or a radiotelephone), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, or a head mounted display), a network device, a server device, a group of server devices, or a similar type of device. In some implementations, the endpoint device 210 may receive network traffic from and/or may provide network traffic to other endpoint devices 210 and/or the server device 230, via the network 240 (e.g., by routing packets using the network devices 220 as intermediaries).

The network device 220 includes one or more devices capable of receiving, processing, storing, routing, and/or providing traffic (e.g., a packet or other information or metadata) in a manner described herein. For example, the network device 220 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 220 may include a gateway, a switch, a firewall, a hub, a bridge, a reverse proxy, a server (e.g., a proxy server, a cloud server, or a data center server), a load balancer, and/or a similar device. In some implementations, the network device 220 may be a physical device implemented within a housing, such as a chassis. In some implementations, the network device 220 may be a virtual device implemented by one or more computer devices of a cloud computing environment or a data center. In some implementations, a group of network devices 220 may be a group of data center nodes that are used to route traffic flow through the network 240.

The server device 230 may include one or more devices capable of receiving, generating, storing, processing, providing, and/or routing information, as described elsewhere herein. The server device 230 may include a communication device and/or a computing device. For example, the server device 230 may include a server, such as an application server, a client server, a web server, a database server, a host server, a proxy server, a virtual server (e.g., executing on computing hardware), or a server in a cloud computing system. In some implementations, the server device 230 may include computing hardware used in a cloud computing environment.

The network 240 includes one or more wired and/or wireless networks. For example, the network 240 may include a packet switched network, a cellular network (e.g., a fifth generation (5G) network, a fourth generation (4G) network, such as a long-term evolution (LTE) network, a third generation (3G) network, and/or a code division multiple access (CDMA) network), a public land mobile network (PLMN), a local area network (LAN), a WAN, a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

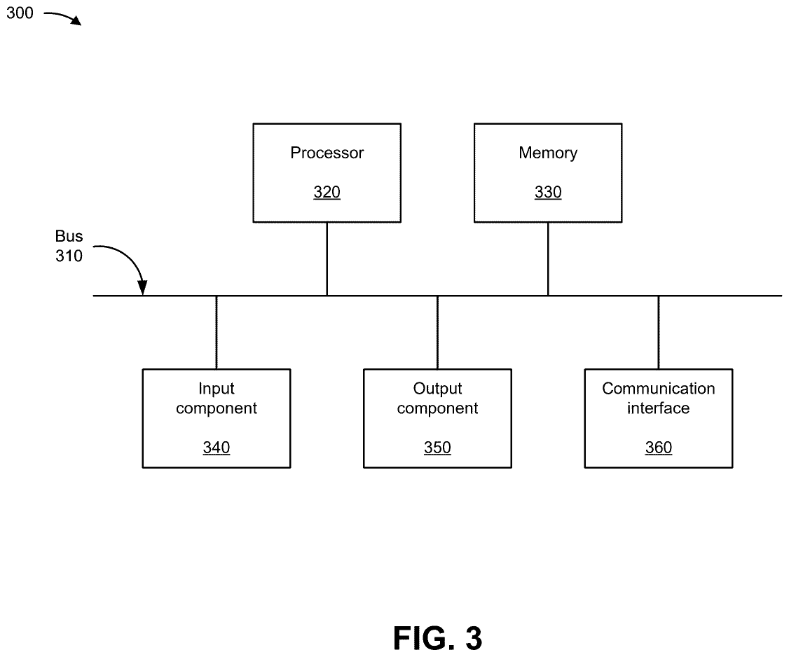

FIG. 3 is a diagram of example components of one or more devices of FIG. 2. The example components may be included in a device 300, which may correspond to the endpoint device 210, the network device 220, and/or the server device 230. In some implementations, the endpoint device 210, the network device 220, and/or the server device 230 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

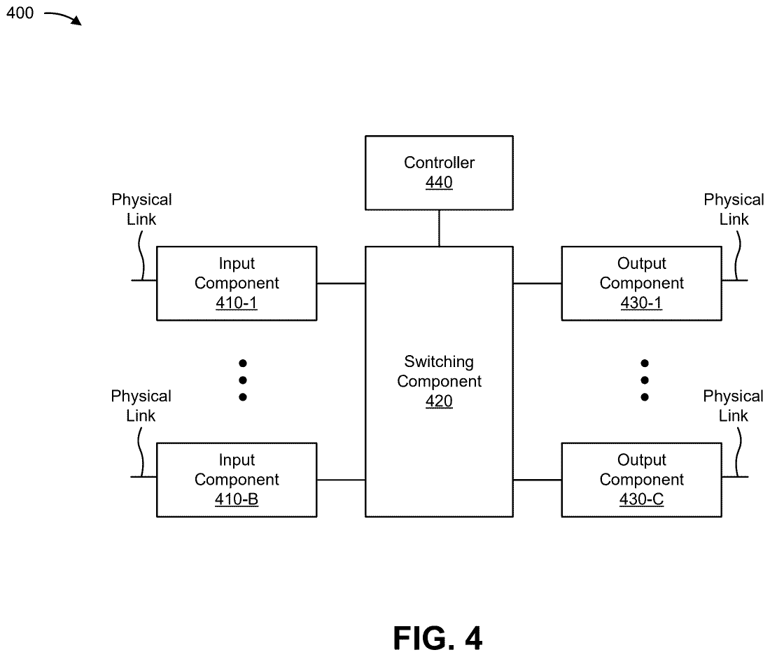

FIG. 4 is a diagram of example components of one or more devices of FIG. 2. The example components may be included in a device 400. The device 400 may correspond to the network device 220. In some implementations, the network device 220 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

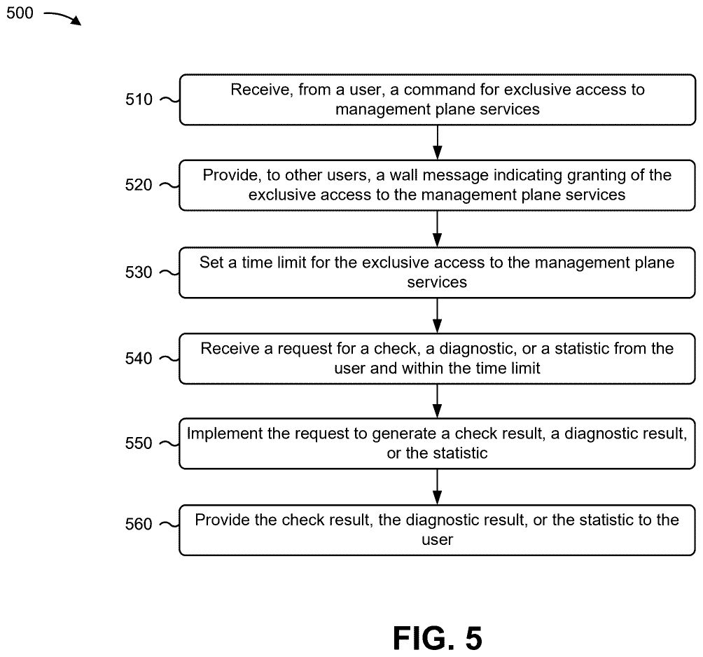

FIG. 5 is a flowchart of an example process 500 for providing access to management plane services of a network device. In some implementations, one or more process blocks of FIG. 5 may be performed by a network device (e.g., a network device 220). In some implementations, one or more process blocks of FIG. 5 may be performed by another device or a group of devices separate from or including the network device, such as an endpoint device (e.g., the endpoint device 210), a server device (e.g., the server device 230), and/or another network device (e.g., the network device 220). Additionally, or alternatively, one or more process blocks of FIG. 5 may be performed by one or more components of the device 300, such as the processor 320, the memory 330, the input component 340, the output component 350, and/or the communication interface 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include receiving, from a user, a command for exclusive access to management plane services (block 510). For example, the network device may receive, from a user, a command for exclusive access to management plane services, as described above. In some implementations, receiving the command for the exclusive access to the management plane services includes receiving the command via a CLI of the network device or via an RPC session established by the network device. In some implementations, the exclusive access to the management plane services enables the user to provide operational commands, remote procedure calls, and configuration updates to the network device.

As further shown in FIG. 5, process 500 may include providing, to other users, a wall message indicating granting of the exclusive access to the management plane services (block 520). For example, the network device may provide, to other users, a wall message indicating granting of the exclusive access to the management plane services, as described above.

As further shown in FIG. 5, process 500 may include setting a time limit for the exclusive access to the management plane services (block 530). For example, the network device may set a time limit for the exclusive access to the management plane services, as described above.

As further shown in FIG. 5, process 500 may include receiving a request for a check, a diagnostic, or a statistic from the user and within the time limit (block 540). For example, the network device may receive a request for a check, a diagnostic, or a statistic from the user and within the time limit, as described above.

As further shown in FIG. 5, process 500 may include implementing the request to generate a check result, a diagnostic result, or the statistic (block 550). For example, the network device may implement the request to generate a check result, a diagnostic result, or the statistic, as described above.

As further shown in FIG. 5, process 500 may include providing the check result, the diagnostic result, or the statistic to the user (block 560). For example, the network device may provide the check result, the diagnostic result, or the statistic to the user, as described above.

In some implementations, process 500 includes providing, to the user and prior to setting the time limit, a response granting the user the exclusive access to the management plane services. In some implementations, process 500 includes preventing existing and new management plane sessions from executing commands during the time limit.

In some implementations, process 500 includes determining that the time limit for the exclusive access to the management plane services has expired, and releasing the exclusive access to the management plane services based on expiration of the time limit. In some implementations, process 500 includes notifying the user of expiration of the exclusive access to the management plane services. In some implementations, process 500 includes providing, to the other users, another wall message indicating expiration of the exclusive access to the management plane services.

In some implementations, process 500 includes receiving, from the user, a request to extend the time limit of the exclusive access to management plane services, and resetting the time limit for the exclusive access to the management plane services based on the request to extend the time limit. In some implementations, process 500 includes receiving, from the user and prior to expiration of the time limit, a request to release the exclusive access to the management plane services, and releasing the exclusive access to the management plane services based on the request to release the exclusive access. In some implementations, process 500 includes providing, to the other users, another wall message indicating the release of the exclusive access to the management plane services.

In some implementations, process 500 includes receiving, from the user, a correction for the network device that is generated based on one or more of the check result, the diagnostic result, or the statistic. In some implementations, process 500 includes validating the user prior to granting of the exclusive access to the management plane services to the user.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device and from a user, a command for exclusive access to management plane services;
providing, by the network device and to other users, a wall message indicating granting of the exclusive access to the management plane services;
setting, by the network device, a time limit for the exclusive access to the management plane services;
receiving, by the network device, a request for a check, a diagnostic, or a statistic from the user and within the time limit;
implementing, by the network device, the request to generate a check result, a diagnostic result, or the statistic; and
providing, by the network device, the check result, the diagnostic result, or the statistic to the user.

2. The method of claim 1, further comprising:
providing, to the user and prior to setting the time limit, a response granting the user the exclusive access to the management plane services.

3. The method of claim 1, further comprising:
preventing existing and new management plane sessions from executing commands during the time limit.

4. The method of claim 1, further comprising:
determining that the time limit for the exclusive access to the management plane services has expired; and
releasing the exclusive access to the management plane services based on expiration of the time limit.

5. The method of claim 4, further comprising:
notifying the user of expiration of the exclusive access to the management plane services.

6. The method of claim 4, further comprising:
providing, to the other users, another wall message indicating expiration of the exclusive access to the management plane services.

7. The method of claim 1, further comprising:
receiving, from the user, a request to extend the time limit of the exclusive access to management plane services; and
resetting the time limit for the exclusive access to the management plane services based on the request to extend the time limit.

8. A network device, comprising:
one or more memories; and
one or more processors to:
receive, from a user, a command for exclusive access to management plane services;
provide, to the user, a response granting the user the exclusive access to the management plane services;
provide, to other users, a wall message indicating granting of the exclusive access to the management plane services;
set a time limit for the exclusive access to the management plane services;
receive a request for a check, a diagnostic, or a statistic from the user and within the time limit;
implement the request to generate a check result, a diagnostic result, or the statistic; and
provide the check result, the diagnostic result, or the statistic to the user.

9. The network device of claim 8, wherein the one or more processors are further to:
receive, from the user and prior to expiration of the time limit, a request to release the exclusive access to the management plane services; and
release the exclusive access to the management plane services based on the request to release the exclusive access.

10. The network device of claim 9, wherein the one or more processors are further to:
provide, to the other users, another wall message indicating the release of the exclusive access to the management plane services.

11. The network device of claim 8, wherein the one or more processors, to receive the command for the exclusive access to the management plane services, are to:
receive the command via a command line interface of the network device or via a remote procedure call session established by the network device.

12. The network device of claim 8, wherein the one or more processors are further to:
receive, from the user, a correction for the network device that is generated based on one or more of the check result, the diagnostic result, or the statistic.

13. The network device of claim 8, wherein the one or more processors are further to:
validate the user prior to granting of the exclusive access to the management plane services to the user.

14. The network device of claim 8, wherein the exclusive access to the management plane services enables the user to provide operational commands, remote procedure calls, and configuration updates to the network device.

15. A non-transitory computer-readable medium storing a set of instructions, the set of instructions comprising:
one or more instructions that, when executed by one or more processors of a network device, cause the network device to:
receive, from a user, a command for exclusive access to management plane services,
wherein the exclusive access to the management plane services enables the user to provide operational commands, remote procedure calls, and configuration updates to the network device;
provide, to other users, a wall message indicating granting of the exclusive access to the management plane services;
set a time limit for the exclusive access to the management plane services;
receive a request for a check, a diagnostic, or a statistic from the user and within the time limit;
implement the request to generate a check result, a diagnostic result, or the statistic; and
provide the check result, the diagnostic result, or the statistic to the user.

16. The non-transitory computer-readable medium of claim 15, wherein the one or more instructions further cause the network device to:
prevent existing and new management plane sessions from executing commands during the time limit.

17. The non-transitory computer-readable medium of claim 15, wherein the one or more instructions further cause the network device to:
determine that the time limit for the exclusive access to the management plane services has expired;
release the exclusive access to the management plane services based on expiration of the time limit;
notify the user of expiration of the exclusive access to the management plane services; and
provide, to the other users, another wall message indicating expiration of the exclusive access to the management plane services.

18. The non-transitory computer-readable medium of claim 15, wherein the one or more instructions further cause the network device to:
receive, from the user, a request to extend the time limit of the exclusive access to management plane services; and
reset the time limit for the exclusive access to the management plane services based on the request the time limit.

19. The non-transitory computer-readable medium of claim 15, wherein the one or more instructions further cause the network device to:
receive, from the user and prior to expiration of the time limit, a request to release the exclusive access to the management plane services;
release the exclusive access to the management plane services based on the request to release the exclusive access; and
provide, to the other users, another wall message indicating the release of the exclusive access to the management plane services.

20. The non-transitory computer-readable medium of claim 15, wherein the one or more instructions further cause the network device to:
receive, from the user, a correction for the network device that is generated based on one or more of the check result, the diagnostic result, or the statistic.
